(19) United States
(12) Patent Application Publication
(10) Pub. No.: US 2013/0165193 A1
(43) Pub. Date: Jun. 27, 2013

(54) Discharge Shield

(71) Applicants: Kevin M. Tacke, Hesston, KS (US); Kevin Hamilton, Newton, KS (US)

(72) Inventors: Kevin M. Tacke, Hesston, KS (US); Kevin Hamilton, Newton, KS (US)

(73) Assignee: AGCO Corporation, Duluth, GA (US)

(21) Appl. No.: 13/335,994

(22) Filed: Dec. 23, 2011

(51) Int. Cl. A01F 12/00

(52) U.S. Cl. 460/111

(57) ABSTRACT

A rotor discharge shield may be disclosed. The rotor discharge shield may comprise a planar wall, a first sidewall, and a second sidewall. The planar wall may define an opening. The first sidewall may be located proximate the opening. The second sidewall may be located proximate the opening. The first sidewall and the second sidewall may define a passage having an inlet and an outlet. An actuator may be arranged to selectively pivot the first sidewall.

### BACKGROUND

Equipment such as, for example, agricultural machines, may receive a material as input. The equipment may also discharge all or a portion of the material received as input.

### BRIEF DESCRIPTION OF THE DRAWINGS

The accompanying drawings, which are incorporated in and constitute a part of this disclosure, illustrate various embodiments of the disclosure. In the drawings:

FIG. 1 is a diagram of a combine; and

FIG. 2 is a rotor discharge shield.

### DETAILED DESCRIPTION

### Overview

A rotor discharge shield may be disclosed. The rotor discharge shield may comprise a planar wall, a first sidewall, and a second sidewall. The planar wall may define an opening. The first sidewall may be located proximate the opening. The second sidewall may be located proximate the opening. The first sidewall and the second sidewall may define a passage having an inlet and an outlet. An actuator may be arranged to selectively pivot the first sidewall.

Both the foregoing general description and the following detailed description are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the detailed description.

### Example Embodiments

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Combines and other farm equipment may receive input materials. For example, a combine may receive grain (e.g., corn) as an input material. All or a portion of the input material may be discharged. For instance, the combine may process the corn or grain and may discharge the material other than grain (MOG) out the rear of the combine.

Depending on the application, the uniformity of the MOG being discharged may need to be controlled. For instance, the combine may discharge the MOG into a baler. The baler may operate more efficiently if the MOG being received has a uniform consistency. As a result, it may be desirable to adjust a discharge opening on the combine to help deliver the MOG with greater uniformity.

While this disclosure describes rotor discharge shields in the context of a combine, embodiments are not limited to an agricultural working environment. In other words, applications where a uniform discharge may be desirable include not only agricultural equipment, but also include, for example, industrial and manufacturing applications.

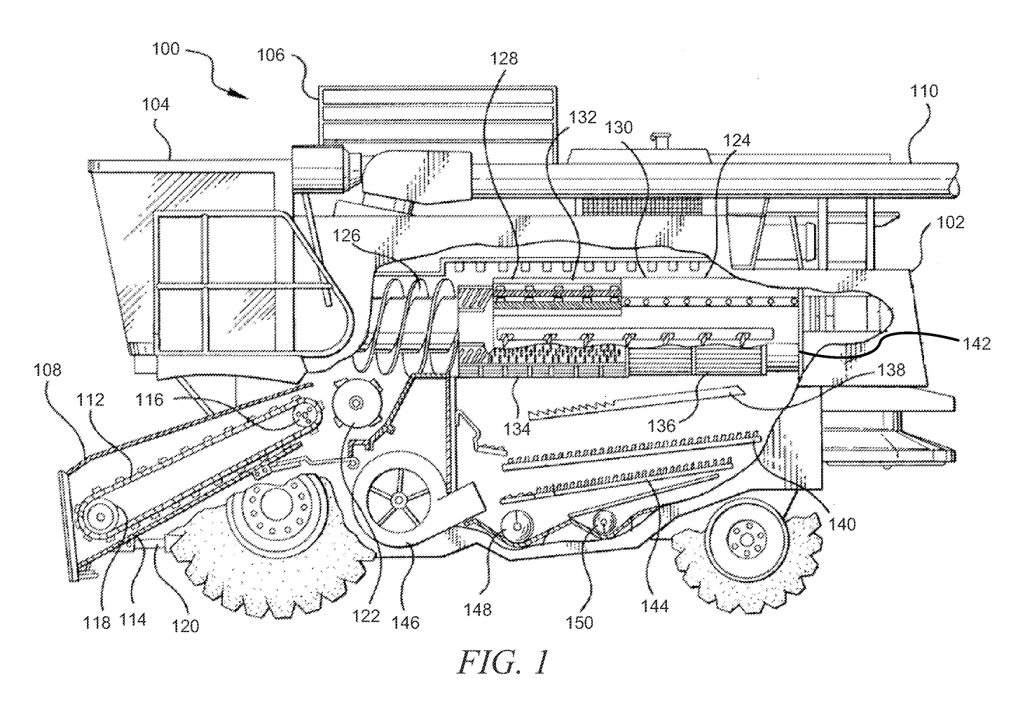

FIG. 1 is a diagram of a combine 100. Combine 100 may comprise a separator housing 102, an operator's work station and cab 104, a grain tank 106, and an elevator assembly 108. A swingable unloading auger assembly 110 may pivot to a position extending laterally outward to one side of combine 100 to unload grain tank 106. Unloading auger assembly 110 may swing inward to a storage position as shown in FIG. 1 when grain tank 106 is not being unloaded.

Elevator assembly 108 may have a conveyor 112 mounted in an elevator housing 114. Conveyor 112 may be trained around rear drive sprockets 116 and a front drum 118. Hydraulic linear actuators 120 may pivot elevator housing 114 to raise and lower the forward end of elevator housing 114.

Crop material may be fed to a feed beater 122 by conveyor 112 in elevator housing 114. Feed beater 122 may feed crop material to a separating rotor 124. Separating rotor 124 may comprise a feed section 126, a threshing section 128, and a separation section 130. Feed section 126 may move crop material in a spiral path about a generally horizontal fore and aft axis of rotation to separating rotor 124, toward threshing section 128. In threshing section 128, crop material may pass between a cylinder bar 132 and a concave 134 where grain may be threshed. Threshed grain, that is not separated by concave 134, may be separated in separation section 130 and may pass through a separation grate 136. A grain pan 138 may convey grain and chaff forward and may deposit it on a chaffer 140.

Grain and MOG that may pass through concave 134 and separation grate 136 may fall to upper grain pan 138. Grain pan 138 may convey grain and chaff forward and may deposit it on chaffer 140. Crop material other than grain (MOG) may be discharged from separating rotor 124 through a rotor discharge shield 142. The grain may be cleaned by chaffer 140 and a sieve 144 and air from a fan assembly 146. Chaff may be discharged from the rear of sieve 144 and chaffer 140. Clean grain may fall into a clean grain auger 148. The clean grain may be conveyed to grain tank 106 by clean grain auger 148 and an elevator (not shown). Tailings may fall into a returns auger 150 and may be conveyed to separating rotor 124 by returns auger and return elevators (not shown), where they may be threshed a second time.

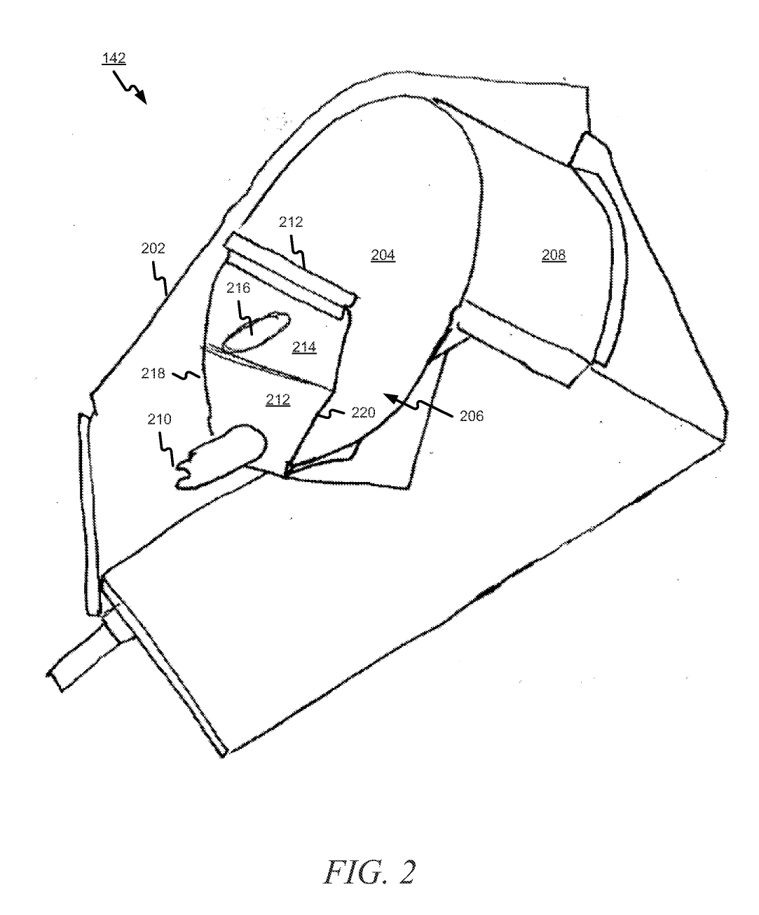

FIG. 2 is a diagram of rotor discharge shield 142. Rotor discharge shield 142 may comprise a planar wall 202 defining an opening 204, a first sidewall 206, a second sidewall 208, and a first actuator 210. First sidewall 206 and second sidewall 208 may be located proximate opening 204. In addition, first sidewall 206 and second sidewall 208 may define a passage having an inlet and an outlet. The inlet may be opening 204 and the outlet me be an exhaust opening located internal or external to combine 100. First actuator 210 may be arranged to selectively pivot first sidewall 206.

For example, first actuator 210 may be configured to receive an input from a baler. The input may cause first sidewall 206 to selectively pivot. In other embodiments, first actuator 210 may be configured to receive an input from an operator operating combine 100. The input may be received while combine 100 is in operation. Thus, first actuator 210 may be able to selectively pivot first sidewall 210 “on the fly” or in substantially real-time.

The input may cause first actuator 210 to extend or retract thereby causing first sidewall 206 to selectively pivot about a hinge 212. While FIG. 2 shows hinge 212 connected to and extending perpendicular from planar wall 202, in various embodiments, hinge 212 may be connected to and not extend perpendicular from planar wall 202. In other words, first sidewall 206′s pivoting axis may be perpendicular to planar wall 202 or it may be at any angle relative to planar wall 202. In addition, first sidewall 206 may be connected to combine 100 at other locations instead of being connected to planar wall 202. For example, first sidewall 206 may be connected to an interior panel of combine 100 and not connected to planar wall 202.

In addition, first sidewall 206 may comprise a first moveable section 212 and a second movable section 214. First actuator 210 may be arranged to selectively pivot first moveable section 212. A second actuator 216 may be arranged to selectively pivot second moveable section 214. First moveable section 212 and second moveable section may be connected to each other. However, first moveable section 212 and second moveable section 214 need not be connected to each other. For instance, first actuator 210 may be arranged to selectively pivot first moveable section 212 and not second movable section 214. Second actuator 216 may be arranged to selectively pivot second moveable section 214 and not first movable section 212.

First sidewall 206 may be constructed of a flexible material and may have a curved or other shaped profile. For example, first sidewall 206 may be constructed of a rubber material and the curved profile may be dependent upon positions of first actuator 210 or second actuator 216. The positions may be defined by inputs received at first actuator 210 or second actuator 216. For instance, first actuator 210 may receive a first signal that may cause first actuator 210 to extend. Second actuator 216 may receive a second signal that may cause second actuator 216 to retract. The extension of first actuator 210 and the retraction of second actuator 216 may cause first sidewall 206 to have a profile defined by the inputs.

First sidewall 206 may comprise a leading edge 218 and a trailing edge 220. First sidewall 206 may pivot about leading edge 218. As first actuator 210 or second actuator 216 extend or retract, trailing edge 220 may cause the cross-sectional area of the outlet of the passage formed by first sidewall 206 and second sidewall 208 to increase or decrease. The increase or decrease in the cross-sectional area may cause the inlet and the outlet to have differing cross-sectional areas.

The above features described with respect to first sidewall 206 may also apply to second sidewall 208 as well. For example, a third actuator (not shown) may be arranged to selectively pivot second sidewall 208. Second sidewall 208 may comprise a plurality of moveable sections and a plurality of actuators to selectively move the plurality of moveable sections.

An embodiment may comprise an apparatus. The apparatus may comprise a planar wall, a first sidewall, and a second sidewall. The planar wall may define an opening. The first sidewall may be located proximate the opening. The second sidewall may be located proximate the opening. The first sidewall and the second sidewall may define a passage having an inlet and an outlet. An actuator may be arranged to selectively pivot the first sidewall.

Another embodiment may comprise an apparatus. The apparatus may comprise a combine having a rotor discharge, a planar wall, a first sidewall, and a second sidewall. The planar wall may define an opening proximate the rotor discharge. The first sidewall may be located proximate the opening. The second sidewall may be located proximate the opening. The first sidewall and the second sidewall may define a passage having an inlet and an outlet. An actuator may be arranged to selectively pivot the first sidewall.

Yet another embodiment may comprise a method. The method may comprise: receiving an input at an actuator; and adjusting the uniformity of a combine rotor discharge by pivoting a sidewall in response to the input received at the actuator. Adjusting the uniformity of a combine rotor discharge may occur in substantially real-time.

Both the foregoing general description and the following detailed description are examples and explanatory only, and should not be considered to restrict the invention's scope, as described and claimed. Further, features and/or variations may be provided in addition to those set forth herein. For example, embodiments may be directed to various feature combinations and sub-combinations described herein.

All rights, including copyrights, in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example embodiments.

What is claimed is:

1. An apparatus comprising:
a planar wall defining an opening, the planar wall located proximate an exit of a rotor;
a first sidewall located proximate the opening;
a second sidewall located proximate the opening, the first sidewall and the second sidewall defining a passage having an inlet and an outlet; and
an actuator arranged to selectively pivot the first sidewall.

2. The apparatus of claim 1, wherein the actuator arranged to selectively pivot the first sidewall comprises the actuator being configured to receive an input from a baler.

3. The apparatus of claim 1, wherein the actuator arranged to selectively pivot the first sidewall comprises the actuator being configured to receive an input from a user.

4. The apparatus of claim 1, wherein the actuator arranged to selectively pivot the first sidewall comprises the actuator being configured to pivot the first sidewall in substantially real-time.

5. The apparatus of claim 1, further comprising a second actuator arranged to selectively pivot the second sidewall.

6. The apparatus of claim 1, further comprising a second actuator,
wherein the first sidewall comprises a first moveable section and a second movable section,
wherein the actuator arranged to selectively pivot the first sidewall comprises the actuator arranged to selectively pivot the first moveable section and not the second movable section,
wherein the second actuator is arranged to selectively pivot the second moveable section and not the first movable section.

7. The apparatus of claim 1, wherein first sidewall comprises a curved profile.

8. The apparatus of claim 1, wherein the first sidewall comprises a flexible material arranged to form a profile, the profile being dependent upon a position of the actuator, the position being defined by an input received at the actuator.

9. The apparatus of claim 1,
wherein the first sidewall comprises a leading edge and a trailing edge, and
wherein the actuator arranged to selectively pivot the first sidewall comprises the actuator arranged to selectively pivot the first sidewall about the leading edge causing the inlet and the outlet to have differing cross-sectional areas.

10. An apparatus comprising:
a combine having a rotor discharge;
a planar wall located proximate the rotor discharge and defining an opening proximate the rotor discharge;
a first sidewall located proximate the opening;
a second sidewall located proximate the opening, the first sidewall and the second sidewall defining a passage having an inlet and an outlet; and
an actuator arranged to selectively pivot the first sidewall.

11. The apparatus of claim 10, wherein the actuator arranged to selectively pivot the first sidewall comprises the actuator being configured to receive an input from a baler.

12. The apparatus of claim 10, wherein the actuator arranged to selectively pivot the first sidewall comprises the actuator being configured to receive an input from a user.

13. The apparatus of claim 10, wherein the actuator arranged to selectively pivot the first sidewall comprises the actuator being configured to pivot the first sidewall in substantially real-time.

14. The apparatus of claim 10, further comprising a second actuator arranged to selectively pivot the second sidewall.

15. The apparatus of claim 10,
further comprising a second actuator,
wherein the first sidewall comprises a first moveable section and a second movable section,
wherein the actuator arranged to selectively pivot the first sidewall comprises the actuator arranged to selectively pivot the first moveable section and not the second movable section,
wherein the second actuator is arranged to selectively pivot the second moveable section and not the first movable section.

16. The apparatus of claim 10, wherein first sidewall comprises a curved profile.

17. The apparatus of claim 10, wherein the first sidewall comprises a flexible material arranged to form a profile, the profile being dependent upon a position of the actuator, the position being defined by an input received at the actuator.

18. The apparatus of claim 10,
wherein the first sidewall comprises a leading edge and a trailing edge, and
wherein the actuator arranged to selectively pivot the first sidewall comprises the actuator arranged to selectively pivot the first sidewall about the leading edge causing the inlet and the outlet to have differing cross-sectional areas.

19. A method comprising:
receiving an input at an actuator; and
adjusting the uniformity of a combine rotor discharge by pivoting a sidewall in response to the input received at the actuator.

20. The method of claim 19, wherein the adjusting the uniformity of a combine rotor discharge occurs in substantially real-time.
